(19) United States
(12) Patent Application Publication
(10) Pub. No.: US 2023/0115263 A1
(43) Pub. Date: Apr. 13, 2023

(54) SHEET-SHAPED HEATING ELEMENT AND HEAT GENERATING DEVICE

(71) Applicant: LINTEC CORPORATION, Tokyo (JP)

(72) Inventors: Masaharu ITO, Itabashi-ku, Tokyo (JP); Takashi MORIOKA, Itabashi-ku, Tokyo (JP)

(21) Appl. No.: 17/801,743

(22) PCT Filed: Feb. 25, 2021
(86) PCT No.: PCT/JP2021/006966

§ 371 Date: Aug. 23, 2022

(30) Foreign Application Priority Data
Feb. 26, 2020 (JP) 2020-030640

(51) Int. Cl. H05B 3/22

(52) U.S. Cl. CPC H05B 3/22

(57) ABSTRACT

A sheet-shaped heat generator includes a pseudo sheet structure including a plurality of metal wires arranged at an interval, the metal wires each including a core including a first metal and a metal film provided on an exterior of the core, the metal film including a second metal different from the first metal, in which a volume resistivity of the first metal is in a range from 1.0×10⁻⁵ [Ω·cm] to 5.0×10⁻⁴ [Ω·cm], and a standard electrode potential of the second metal is +0.34 V or more.

### TECHNICAL FIELD

The present invention relates to a sheet-shaped heat generator and a heat generating device.

### BACKGROUND ART

A known sheet-shaped heat generator includes a pseudo sheet structure where a plurality of metal wires are arranged at intervals. The sheet-shaped heat generator may be usable as, for instance, a material of a heating textile, a member that causes a variety of articles to generate heat, and a heat generator in a heat generating device.

For instance, Patent Literature 1 discloses, as a sheet for use in a heat generator, a sheet including a pseudo sheet structure where a plurality of linear bodies having a volume resistivity R in a range from 1.0×10⁻⁷ Ωcm to 1.0×10⁻¹ Ωcm and that unidirectionally extend are arranged in parallel with each other at intervals. With regard to the sheet, a relationship between a diameter D of the linear bodies and an interval L between adjacent ones of the linear bodies satisfies an expression: L/D≥3 and a relationship among the diameter D of the linear bodies, the interval L between adjacent ones of the linear bodies, and the volume resistivity R of the linear bodies satisfies an expression: (D²/R)×(1/L)≥0.003 (in the expression, units of D and L: cm).

In addition, Patent Literature 2 discloses a heat generating sheet for three-dimensional forming including a pseudo sheet structure where a plurality of unidirectionally extending metal wires are arranged at intervals. The heat generating sheet for three-dimensional forming includes the pseudo sheet structure including the metal wires having a diameter of 7 μm to 75 μm and a resin protection layer provided on one surface of the pseudo sheet structure and a total thickness of layers provided on the surface of the pseudo sheet structure where the resin protection layer is provided is 1.5 to 80 times as large as a diameter of the metal wires.

In addition, it is suggested that the heat generating sheet is usable for a variety of purposes. For instance, Patent Literature 3 discloses an anti-adhesion sheet for snow and ice including a base material and a heating element provided on the base material and including a plurality of electrically conductive linear bodies. When stuck to a structure, the anti-adhesion sheet for snow and ice has an exposed surface, on which a contact angle of water is 90 degrees or more.

### CITATION LIST

### Patent Literature(s)

Patent Literature 1: WO 2017/086395
Patent Literature 2: WO 2018/097321
Patent Literature 3: JP 2018-039226 A

### SUMMARY OF THE INVENTION

### Problem(s) to be Solved by the Invention

In a case where a heat generating sheet is used as a sheet that prevents adhesion of snow and ice to a structure as described in Patent Literature 3, it is necessary to increase an output voltage. In such a case, if the heat generating sheet has a low resistance, an electric power generated in the heat generating sheet would become excessively large, resulting in overheating.

In addition, in a case where the heat generating sheet described in Patent Literature 1 or 2 is attached to an electrode and caused to generate heat, a resistance of a connection between the linear bodies or the metal wires and the electrode is likely to increase. An increase in the resistance of the connection between the linear bodies or the metal wires and the electrode would cause an electrode part connected to the linear bodies or the metal wires to abnormally generate heat.

An object of the invention is to provide a sheet-shaped heat generator and a heat generating device including the sheet-shaped heat generator, the sheet-shaped heat generator being able to be, when attached to electrodes and caused to generate heat, prevented from overheating and reduced in resistance of a connection between a metal wire and the electrodes even though used for a purpose requiring a large output.

### Means for Solving the Problem(s)

According to an aspect of the invention, a sheet-shaped heat generator is provided, the sheet-shaped heat generator including a pseudo sheet structure including a plurality of metal wires arranged at an interval, the metal wires each including a core including a first metal and a metal film provided on an exterior of the core, the metal film including a second metal different from the first metal, in which a volume resistivity of the first metal is in a range from 1.0×10⁻⁵ [Ω·cm] to 5.0×10⁻⁴ [Ω·cm], and a standard electrode potential of the second metal is +0.34 V or more.

In the sheet-shaped heat generator according to the above aspect of the invention, it is preferable that the interval between the metal wires be in a range from 0.3 mm to 30 mm.

In the sheet-shaped heat generator according to the above aspect of the invention, it is preferable that a diameter of each of the metal wires be in a range from 5 μm to 150 μm.

In the sheet-shaped heat generator according to the above aspect of the invention, it is preferable that the first metal contains, as a main component, at least one metal selected from the group consisting of titanium, stainless steel, and iron-nickel.

In the sheet-shaped heat generator according to the above aspect of the invention, it is preferable that the second metal contains, as a main component, at least one metal selected from the group consisting of silver and gold.

In the sheet-shaped heat generator according to the above aspect of the invention, it is preferable that the sheet-shaped heat generator includes an adhesive agent layer and the pseudo sheet structure be in contact with the adhesive agent layer.

In the sheet-shaped heat generator according to the above aspect of the invention, it is preferable that the sheet-shaped heat generator be usable for reducing adhesion of snow and ice on a surface.

According to another aspect of the invention, a heat generating device including: the sheet-shaped heat generator according to the above aspect of the invention; and electrodes is provided.

In the heat generating device according to the above aspect of the invention, it is preferable that the second metal of the metal wires be brought into contact with the electrodes in use.

In the heat generating device according to the above aspect of the invention, it is preferable that the metal wires be fixed to the electrodes using the adhesive agent layer in use.

According to the aspects of the invention, it is possible to provide a sheet-shaped heat generator and a heat generating device including the sheet-shaped heat generator, the sheet-shaped heat generator being able to be, when attached to electrodes and caused to generate heat, prevented from overheating and reduced in resistance of a connection between a metal wire and the electrodes even though used for a purpose requiring a large output.

### BRIEF DESCRIPTION OF DRAWING(S)

FIG. 1 is a schematic perspective view illustrating a sheet-shaped heat generator according to a first exemplary embodiment.

FIG. 2 is a cross-sectional view illustrating a cross section taken along II-II in FIG. 1.

FIG. 3 is a schematic cross-sectional view of a metal wire according to the first exemplary embodiment.

FIG. 4 is a schematic perspective view illustrating a heat generating device according to the first exemplary embodiment.

FIG. 5 is a schematic perspective view illustrating a sheet-shaped heat generator according to a second exemplary embodiment.

FIG. 6 is a schematic perspective view illustrating a sheet-shaped heat generator according to a third exemplary embodiment.

FIG. 7 is a schematic perspective view illustrating a sheet-shaped heat generator according to a fourth exemplary embodiment.

FIG. 8 is a schematic perspective view illustrating a heat generating device according to a fifth exemplary embodiment.

FIG. 9 is a cross-sectional view illustrating a manner of contact between an electrode and metal wires.

FIG. 10 is a cross-sectional view illustrating another manner of contact between the electrode and the metal wires.

FIG. 11 is a cross-sectional view illustrating still another manner of contact between the electrode and the metal wires.

### DESCRIPTION OF EMBODIMENT(S)

### First Exemplary Embodiment

Description will be made below on the invention with reference to the drawings with an exemplary embodiment cited as an example. The invention is not limited to the contents of the exemplary embodiment. It should be noted that some parts are illustrated on an enlarged scale or a reduced scale in the drawings for the convenience of explanation.

### Sheet-Shaped Heat Generator

A sheet-shaped heat generator 10 according to a first exemplary embodiment is attached to an electrode in use.

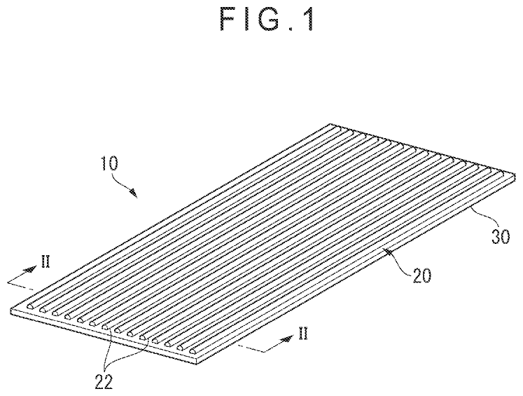

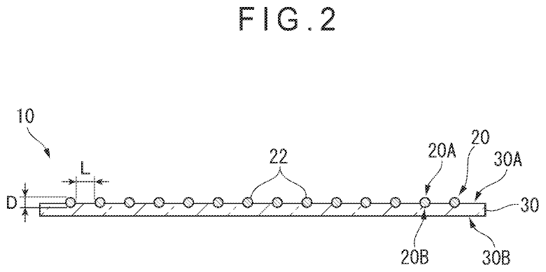

The sheet-shaped heat generator 10 according to this exemplary embodiment includes, for instance, a pseudo sheet structure 20 with a plurality of metal wires 22 arranged at intervals and an adhesive agent layer 30 as illustrated in FIG. 1 and FIG. 2. Specifically, for instance, in the sheet-shaped heat generator 10, the pseudo sheet structure 20 is stacked on the adhesive agent layer 30.

It should be noted that 20A denotes a surface (hereinafter, referred to as “first surface 20A”) of the pseudo sheet structure 20 opposite a surface on which the adhesive agent layer 30 is stacked hereinafter. 20B denotes the surface (hereinafter, referred to as “second surface 20B”) of the pseudo sheet structure 20 on which the adhesive agent layer 30 is stacked (see FIG. 2). 30A denotes a surface (hereinafter, referred to as “first adhesive surface 30A”) of the adhesive agent layer 30 on which the pseudo sheet structure 20 is stacked. 30B denotes a surface (hereinafter, referred to as “second adhesive surface 30B”) of the adhesive agent layer 30 opposite the surface on which the pseudo sheet structure 20 is stacked (see FIG. 2).

In other words, in the sheet-shaped heat generator 10 according to this exemplary embodiment, the pseudo sheet structure 20 and the adhesive agent layer 30 are stacked on each other with the second surface 208 of the pseudo sheet structure 20 and the first adhesive surface 30A of the adhesive agent layer 30 facing each other.

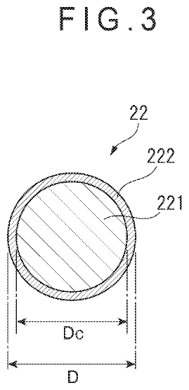

The metal wires 22 of this exemplary embodiment each include a core 221 including a first metal and a metal film 222 provided on an exterior of the core 221 and including a second metal different from the first metal as illustrated in FIG. 3. In FIG. 3, D denotes a diameter of the metal wires 22 and Dc denotes a diameter of the core 221.

A volume resistivity of the first metal (hereinafter, also referred to as “volume resistivity R_{M1}”) is in a range from 1.0×10⁻⁵ [Ω·cm] to 5.0×10⁻⁴ [Ω·cm].

A standard electrode potential of the second metal (hereinafter, also referred to as “standard electrode potential E_{M2}”) is +0.34 V or more.

The sheet-shaped heat generator 10 of this exemplary embodiment can be prevented from overheating even in a case where the sheet-shaped heat generator 10 is used for a purpose requiring a large output. In addition, the sheet-shaped heat generator 10 can be attached to the electrode and caused to generate heat with a resistance of a connection between the metal wires 22 and the electrode being reduced.

The reason why the above-described effects of this exemplary embodiment are achieved is speculated as follows.

In a case where a sheet-shaped heat generator with a plurality of metal wires arranged is attached to an electrode in use, it should be necessary to set a volume resistivity of the metal wires higher than that of lines such as copper lines. This can increase a resistance of the metal wires, enabling the sheet-shaped heat generator to generate heat.

In addition, in a case where the sheet-shaped heat generator is used for a purpose requiring a large output, if a later-described heat generating device has a low resistance, an electric power generated in the sheet-shaped heat generator would become excessively large, resulting in overheating. Accordingly, in this exemplary embodiment, the volume resistivity of the metal wires is set relatively high, which makes it possible to prevent a phenomenon of the electric power becoming excessively large to prevent overheating.

On the other hand, the metal wires with a relatively high volume resistivity tend to be relatively low in standard electrode potential and are thus characteristically likely to suffer generation of an oxide film on surfaces of the metal wires due to a change with time elapsed after production. With the oxide film generated on the surfaces, the resistance of the connection between the metal wires and the electrode or a connection member increases, which sometimes results in abnormal heat generation of an electrode part connected to the metal wires.

Here, abnormal heat generation refers to a state where a temperature of the electrode part where the metal wires and the electrode are connected becomes higher than that of a region where no electrode is present and only the pseudo sheet structure generates heat.

A temperature of the electrode part connected to the metal wires resulting from applying a voltage of 200 V for 30 seconds to a sheet-shaped heat generator having been stored under a hygrothermal environment (85 degrees C., relative humidity 85%) for 20 hours is used as an index of abnormal heat generation herein. The details will be described in Example section.

For the sheet-shaped heat generator 10 of this exemplary embodiment, the metal wires 22 each provided with the metal film 222, which contains the second metal as a main component, on the exterior of the core 221, which contains the first metal as a main component, are employed as the plurality of metal wires 22 constituting the pseudo sheet structure 20 as illustrated in FIG. 3.

Further, the volume resistivity R_{M1} of the first metal is set as relatively high as in a range from 1.0×10⁻⁵ [Ω·cm] to 5.0×10⁻⁴ [Ω·cm] and the standard electrode potential E_{M2} of the second metal is set as relatively high as +0.34 V or more.

By virtue of the volume resistivity R_{M1} of the first metal being in the above range, the core 221 is likely to generate heat and the sheet-shaped heat generator 10 can be prevented from overheating even in a case where used for a purpose requiring a large output. In addition, by virtue of the standard electrode potential E_{M2} of the second metal being in the above range, an oxide film is unlikely to be generated on the surfaces of the metal wires 22 (i.e., the surface of the metal film 222) due to a change with time after production.

That is to say, the metal wires 22 of this exemplary embodiment allow for achieving a balance between a function to reduce occurrence of a large electric power at a high output and a reduction in generation of an oxide film on the surfaces of the metal wires.

Meanwhile, the sheet-shaped heat generator 10, which includes the pseudo sheet structure with the plurality of metal wires arranged, is likely to abnormally generate heat when attached to an electrode and caused to generate heat. However, in this exemplary embodiment, the resistance of the connection between the metal wires 22 and the electrode can be reduced, allowing for preventing such abnormal heat generation of the electrode part.

### Pseudo Sheet Structure

The pseudo sheet structure 20 has a structure where the plurality of unidirectionally extending metal wires 22 are arranged at intervals therebetween. That is to say, the pseudo sheet structure 20 is a structure where the plurality of metal wires 22 are arranged at intervals therebetween to form a flattened surface or a curved surface. Specifically, for instance, the pseudo sheet structure 20 has a structure where the plurality of linearly extending metal wires 22 are arranged at regular intervals in a direction perpendicular to a length direction of the metal wires 22. In other words, the pseudo sheet structure 20 has, for instance, a structure where the metal wires 22 are arranged in stripes.

### Metal Wires

The metal wires 22 each include the core 221 and the metal film 222 provided on the exterior of the core 221.

### Core

The core 221 includes the first metal. It should be noted that the first metal is a concept including alloy.

The volume resistivity R_{M1} of the first metal is in a range from 1.0×10⁻⁵ [Ω·cm] to 5.0×10⁻⁴ [Ω·cm], preferably in a range from 3.0×10⁻⁵ [Ω·cm] to 1.5×10⁻⁴ [Ω·cm], more preferably in a range from 4.0×10⁻⁴ [Ω·cm] to 9.0×10⁻⁵ [Ω·cm].

At the volume resistivity R_{M1} of the first metal of 1.0×10⁻⁵ [Ω·cm] or more, the metal wires 22 are likely to generate heat and the sheet-shaped heat generator 10 can be prevented from overheating even in a case where used for a purpose requiring a large output.

At the volume resistivity R_{M1} of the first metal of 5.0×10⁻⁴ [Ω·cm] or less, a resistance between the electrodes at the time when the sheet-shaped heat generator is attached to the electrode and caused to generate heat is likely to decrease. This leads to an effect to prevent the resistance of the heat generating device from excessively increasing even though a distance between the electrodes is increased due to application to a large area of a sign, a signboard, or the like. In addition, as long as the volume resistivity R_{M1} of the first metal is 9.0×10⁻⁵ [Ω·cm] or less, the resistance of the heat generating device is favorably prevented from excessively increasing even though the diameter of the metal wires 22 is approximately 50 μm or less and the distance between the electrodes is increased due to application to a large area of a sign, a signboard, or the like.

The volume resistivity R_{M1} of the first metal is a known value at 25 degrees C., that is, a value mentioned in Kagaku Binran (Kiso-hen) (Handbook of Chemistry (Basic)), revised 4th edition (editor: The Chemical Society of Japan). A value of the volume resistivity R_{M1} of an alloy not mentioned in Kagaku Binran is a value disclosed by a manufacturer of the alloy.

In a case where the first metal with the volume resistivity R_{M1} in the above range is used, standard electrode potentials (hereinafter, also referred to as “EMI”) of almost all the metals usable as the first metal are less than +0.34 V with consideration for production costs, etc. as well.

In this exemplary embodiment, even if the first metal with the standard electrode potential E_{M1} of less than +0.34 V is used, an oxide film is unlikely to be generated on the surfaces of the metal wires 22 due to a change with time elapsed after production by virtue of the standard electrode potential E_{M2} of the second metal being within the predetermined range as described above.

The standard electrode potential E_{M1} of the first metal is a material-inherent value, which is a known value.

The standard electrode potential E_{M1} of the first metal is determined by the following method.

It should be noted that in a case where the first metal is stainless steel, the standard electrode potential of stainless steel is supposed to be less than +0.34 V in view of the fact that all of the standard electrode potentials of metals constituting stainless steel, i.e., iron, chromium, and nickel, are negative values and the amount of carbon contained in stainless steel is usually small.

An alloy tends to exhibit a considerably lower standard electrode potential than a metal component with a larger standard electrode potential even when an additive amount of a metal component with a smaller standard electrode potential is small, since the metal component with the smaller standard electrode potential is first ionized by corrosion. For instance, in a case where the first metal is iron-nickel, the standard electrode potential of iron-nickel is assumed to be less than +0.34 V as being rather close to the standard electrode potential of iron in view of the fact that precipitation of iron first occurs, the standard electrode potential of nickel is −0.257 V, and the standard electrode potential of iron is −0.44 V.

The core 221 is not limited as long as it includes the first metal.

Examples of the first metal include metals containing, as main components, titanium (4.2×10⁻⁵), stainless steel (7.3×10⁻⁵), iron-nickel (5.0×10⁻⁵), Nichrome® (1.0×10⁻⁴), KANTHAL® (1.45×10⁻⁴), and HASTELLOY® (1.3×10⁻⁴). Numerical values in the brackets indicate volume resistivities of the metals or the alloys (unit: Ω·cm).

Among the above, the first metal more preferably contains, as a main component, at least one metal selected from the group consisting of titanium, stainless steel, and iron-nickel in terms of a volume resistivity being not as high as that of Nichrome® and the resistance of the heat generating device being prevented from excessively increasing even though the diameter of the metal wires 22 is approximately 50 μm or less and the distance between the electrodes is increased due to application to a large area of a sign, a signboard, or the like. In consideration of price, corrosion resistance, etc., the first metal further preferably contains stainless steel as a main component.

Here, the wording “contain . . . as a main component” means that the above metal accounts for 50 mass % or more of the entirety of the first metal. A ratio of the above metal to the entirety of the first metal is preferably 70 mass % or more, more preferably 80 mass % or more, further preferably 90 mass % or more. In addition, in a case where the metal contained as a main component is an alloy, which may be stainless steel, the above mass ratio refers to a mass ratio of the total amount of carbon, chromium, nickel, and iron.

A shape of a cross section of the core 221 is not limited and may be polygonal shape, a flat shape, an oval shape, a circular shape, or the like. The shape of the cross section of the core 221 is preferably an oval shape or a circular shape in terms of, for instance, affinity of the metal wire 22 to the adhesive agent layer 30.

In a case where the cross section of the core 221 is in a circular shape, in terms of facilitating adjustment of the diameter of the metal wire 22 to fall within a later-described range, a diameter Do of the core 221 is preferably in a range from 4 μm to 149 μm, more preferably in a range from 6 μm to 99 μm, further preferably in a range from 9 μm to 79 μm, further more preferably in a range from 9 μm to 49 μm.

In a case where the cross section of the core 221 is in an oval shape, a long diameter is preferably in a range similar to that of the above diameter Dc.

### Metal Film

The metal film 222 includes the second metal. The second metal is different from the first metal. The second metal is a concept including alloy as the first metal.

The standard electrode potential E_{M2} of the second metal is +0.34 V or more, preferably +0.5 V or more, more preferably +0.7 V or more, further preferably +1.0 V or more. An upper limit of the standard electrode potential E_{M2} of the second metal is +2.0 V or less, more preferably +1.6 V or less.

Abnormal heat generation, which would occur when the sheet-shaped heat generator 10 is attached to an electrode, is unlikely to occur in a case where a single electrode is attached to each end of each metal wire 22, whereas being more likely to occur in a case where a single electrode is attached to ends of the plurality of metal wires 22 due to the presence of a plurality of portions where the metal wires 22 and the electrode are connected.

At the standard electrode potential E_{M2} of the second metal of +0.34 V or more, abnormal heat generation is unlikely to occur when the sheet-shaped heat generator 10 is attached to the electrode. In addition, the formation of an oxide film on the surfaces of the metal wires 22 with time can be reduced, so that other abnormalities resulting from the formation of the oxide film are likely to be reduced.

For instance, metal wires each having a core coated with graphite do not suffer formation of an oxide film but the resistance of the connection between the metal wires and the electrode cannot be reduced. In contrast, for instance, the metal wires 22 each having the core 221 coated with gold, the standard electrode potential E_{M2} of which is high, is favorable in terms of both a reduction in formation of an oxide film and the resistance of the connection between the metal wires and the electrode.

The standard electrode potential E_{M2} of the second metal is a material-inherent value.

A volume resistivity R_{M2} of the second metal is preferably less than 2.0×10⁻⁵ [Ω·cm], more preferably less than 1.5×10⁻⁵ [Ω·cm], further preferably less than 3.0× 10⁻⁶ [Ω·cm]. A lower limit of the volume resistivity R_{M2} of the second metal is preferably 1.0×10⁻⁶ [Ω·cm] or more.

At the volume resistivity R_{M2} of the second metal of less than 2.0×10⁻⁵ [Ω·cm], the resistance of the connection between the metal wires 22 and the electrode is likely to be reduced as compared with in a case where metal wires (core) with no metal film are connected to the electrode.

The volume resistivity R_{M2} of the second metal is a known value at 25 degrees C., that is, a value mentioned in Kagaku Binran (Kiso-hen) (Handbook of Chemistry (Basic)), revised 4th edition (editor: The Chemical Society of Japan). A value of the volume resistivity R_{M2} of an alloy not mentioned in Kagaku Binran is a value disclosed by a manufacturer of the alloy.

The metal film 222, which includes the second metal, is not limited as long as the standard electrode potential E_{M2} of the second metal is +0.34 V or more.

Examples of the second metal include metals containing, as main components, gold, platinum, palladium, silver, copper, and an alloy. Examples of the alloy include an alloy containing, as a main component, an alloy containing at least one metal selected from the group consisting of gold, platinum, palladium, silver, and copper. It should be noted that the alloy is preferably an alloy of metals selected from the group consisting of gold, platinum, palladium, silver, and copper; however, an alloy containing a metal other than the above, such as nickel, iron, or cobalt, is also acceptable as long as the content thereof is small enough to provide only a small influence on the standard electrode potential of the second metal. Examples of such an alloy include a gold-nickel alloy, a gold-iron alloy, and a gold-cobalt alloy.

The second metal preferably contains, as a main component, at least one selected from the group consisting of gold, platinum, palladium, silver, copper, and the alloy (an alloy containing at least one metal selected from the group consisting of gold, platinum, palladium, silver, and copper), more preferably contains, as a main component, at least one selected from the group consisting of gold, platinum, palladium, silver, and the alloy, particularly preferably contains, as a main component, at least one selected from the group consisting of gold and silver.

Here, the wording “contain . . . as a main component” means that the above metal accounts for 50 mass % or more of the entirety of the second metal. A ratio of the above metal to the entirety of the second metal is preferably 80 mass % or more, more preferably 90 mass % or more, further preferably 100 mass %. In addition, in a case where the metal contained as a main component is an alloy, which may be a gold-nickel alloy, the above mass ratio refers to a mass ratio of the total amount of gold and nickel.

A thickness of the metal film 222 is preferably in a range from 0.01 μm to 3 μm in terms of a reduction in the resistance of the connection between the metal wires 22 and the electrode, more preferably in a range from 0.02 μm to 1 μm, further preferably in a range from 0.03 μm to 0.7 μm.

The thickness of the metal film 222 is measured by, for instance, observing a cross section of each of the metal wires 22 of the pseudo sheet structure 20 with an electron microscope (for instance, manufactured by Carl Zeiss Meditec AG, Product No. Cross Beam 550).

The metal wires 22 may each include an intermediate layer between the core 221 and the metal film 222. By virtue of the metal wires 22 each including the intermediate layer, it is possible to reduce dispersion of a metal contained in the core 221. The intermediate layer serves to protect the core 221, making the properties (volume resistivity, etc.) of the core 221 likely to be kept.

The intermediate layer can be formed by a method similar to that of the metal film 222.

Examples of the intermediate layer include layers of metals different from the second metal, such as a nickel layer, a nickel alloy layer, a tin layer, a tin alloy layer, a copper alloy layer, a niobium layer, a niobium alloy layer, a titanium layer, a titanium alloy layer, a molybdenum layer, a molybdenum alloy layer, a tungsten layer, a tungsten alloy layer, a palladium alloy layer, and a platinum alloy layer.

A thickness of the intermediate layer is preferably in a range from 0.01 μm to 1 μm, more preferably in a range from 0.02 μm to 1 μm, further preferably in a range from 0.03 μm to 0.7 μm.

### Shape, Interval L, and Diameter D of Metal Wires

The metal wires 22 may each be a linear body of a single metal wire 22 or a linear body of a plurality of twisted metal wires 22.

In terms of the individual metal wires 22 becoming difficult to see in the pseudo sheet structure 20, the interval L between the metal wires 22 is preferably in a range from 0.3 mm to 2 mm, more preferably in a range from 0.5 mm to 1.5 mm. In terms of facilitating an increase in light transmittance of the pseudo sheet structure 20, the interval L between the metal wires 22 is preferably in a range from 3 mm to 30 mm, more preferably in a range from 5 mm to 20 mm, further preferably in a range from 7 mm to 15 mm.

In addition, as long as the interval L between the metal wires 22 is 0.3 mm or more, in a case where the sheet-shaped heat generator 10 includes the adhesive agent layer 30 and a constituent member of the sheet-shaped heat generator is to be bonded to the adhesive agent layer or the sheet-shaped heat generator is to be bonded to an adherend via the adhesive agent layer, an exposed area of the adhesive agent layer 30 exposed between the metal wires 22 can be ensured to prevent the metal wires 22 from disturbing the bonding between the adhesive agent layer 30, which is exposed through the pseudo sheet structure 20, and the constituent member or the adherend.

In addition, as long as the interval L between the metal wires 22 is maintained within a small range as described above, the metal wires 22 are at rather densely arranged, allowing for improving a function of the sheet-shaped heat generator 10 such as equalization of distribution of temperature rise. In this case, the resistance of the heat generating device tends to decrease; however, in this exemplary embodiment, the resistance of the heat generating device is likely to be kept high by virtue of the high volume resistivity R_{M1} of the first metal, which constitutes the cores 221 of the metal wires 22. In a case where the interval between the metal wires 22 is 2 mm or less, the resistance of the heat generating device tends to further decrease and, accordingly, it is preferable that the first metal contain Nichrome® or the like, which has a high volume resistivity. In contrast, in a case where the interval between the metal wires 22 is 3 mm or more, the resistance of the heat generating device tends to relatively increase and, accordingly, it is preferable that the first metal contain titanium, stainless steel, iron-nickel, or the like, which has a relatively low volume resistivity.

For the interval L between the metal wires 22, an interval between adjacent two of the metal wires 22 is measured by observing the metal wires 22 of the pseudo sheet structure 20 with a digital microscope (manufactured by KEYENCE CORPORATION, Product No. VHX-6000).

It should be noted that the interval L between adjacent two of the metal wires 22 corresponds to a length along a direction in which the metal wires 22 are arranged (a direction perpendicular to a direction of extension of the metal wires 22), that is, a length between facing portions of the two metal wires 22 (see FIG. 2).

In a case where the metal wires 22 are arranged at irregular intervals, the interval L is an average value of intervals between all the adjacent ones of the metal wires 22. However, in terms of controllability of the value of the interval L, the metal wires 22 are preferably arranged substantially at regular intervals in the pseudo sheet structure 20, more preferably arranged at regular intervals.

In a case where the metal wires 22 are each in a wavy shape as described later, the metal wires 22 are partially closer to each other beyond the interval L due to the curvature or bend of the metal wires 22 and, accordingly, it is sometimes preferable that the interval L be wider. In such a case, the interval L between the metal wires 22 is preferably in a range from 1 mm to 30 mm, more preferably in a range from 2 mm to 20 mm.

A shape of a cross section of each of the metal wires 22 is not limited and may be polygonal shape, a flat shape, an oval shape, a circular shape, or the like. The shape of the cross section of each of the metal wires 22 is preferably an oval shape or a circular shape in terms of, for instance, affinity to the adhesive agent layer 30.

In a case where the cross section of each of the metal wires 22 is in a circular shape, the diameter D of each of the metal wires 22 is preferably in a range from 5 μm to 150 μm, more preferably in a range from 7 μm to 100 μm, further preferably in a range from 10 μm to 80 μm, further more preferably 10 μm to 50 μm in terms of controlling the resistance of the heat generating device, improving heat generation efficiency and anti-insulation/breakage properties, making the metal wires 22 visually and tactually less noticeable, and making a beam likely to evenly pass through the sheet-shaped heat generator 10. Such thinned metal wires are significantly likely to experience a rise in the resistance of the connection between the metal wires 22 and the electrode and abnormal heat generation of the electrode part described above; however, in this exemplary embodiment, such abnormal heat generation of the electrode part is reduced. In addition, the diameter D of the metal wires 22 of 5 μm or more has an effect in making the metal wires 22 less breakable as a result of an increase in a strength thereof. On the other hand, in a case where the diameter D of the metal wires 22 is 5 μm or more, a linear resistance of the metal wires 22 is likely to decrease. However, in this exemplary embodiment, the volume resistivity of the first metal is 1.0×10⁻⁵ Ω·cm or more, which makes it possible to keep the linear resistance of the metal wires 22 high.

In a case where the cross section of each of the metal wires 22 is in an oval shape, it is preferable that a long diameter be in a range similar to that of the above diameter D.

The diameter D of the metal wires 22 is an average value of results of measuring the diameter D of the metal wires 22 at five spots selected at random by observing the cross section of each of the metal wires 22 of the pseudo sheet structure 20 with a digital microscope (manufactured by KEYENCE CORPORATION, Product No. VHX-6000).

### Adhesive Agent Layer

The adhesive agent layer 30 is a layer containing an adhesive agent. It should be noted that the adhesive agent layer 30 is a layer that is provided, if necessary.

It is preferable that the pseudo sheet structure 20 be in contact with the adhesive agent layer 30.

The sheet-shaped heat generator 10 includes the adhesive agent layer 30 stacked on the second surface 20B of the pseudo sheet structure 20. The adhesive agent layer 30, which fixes the arrangement of the metal wires 22, allows the pseudo sheet structure 20 to be easily formed and allows the sheet-shaped heat generator 10 to be easily stuck to an adherend.

On the other hand, a component contained in the adhesive agent layer 30 makes an oxide film likely to be generated on the metal wires 22, which would increase, when the sheet-shaped heat generator 10 is attached to the electrode, a possibility of a rise in the resistance of the connection between the metal wires 22 and the electrode. However, the metal wires 22 of this exemplary embodiment, each of which is provided with the metal film 222 around the core 221 in advance, enable a reduction in the generation of an oxide film with time elapsed after production.

The sheet-shaped heat generator 10 can be bonded to an adherend with the first surface 20A facing the adherend. In this case, the first adhesive surface 30A of the adhesive agent layer 30 exposed through the pseudo sheet structure 20 in the sheet-shaped heat generator 10 makes it easy to bond the sheet-shaped heat generator 10 to the adherend as described above. Alternatively, the sheet-shaped heat generator 10 may be bonded to an adherend with the second adhesive surface 30B facing the adherend.

It is preferable that the adhesive agent layer 30 be curable. With the adhesive agent layer 30 cured, a hardness sufficient for protecting the pseudo sheet structure is provided to the adhesive agent layer 30. In addition, the cured adhesive agent layer 30 is improved in impact resistance, so that deformation of the cured adhesive agent layer 30 due to impact can be reduced.

It is preferable that the adhesive agent layer 30 be curable with an energy ray such as an ultraviolet ray, a visible energy ray, an infrared ray, or an electron ray so that it can be easily cured in a short time. It should be noted that “curing with an energy ray” includes thermal curing by energy-ray heating.

Conditions for the energy-ray curing are different depending on an energy ray used. For instance, in a case where the adhesive agent layer 30 is to be cured by ultraviolet irradiation, an irradiation amount of the ultraviolet ray is preferably in a range from 10 mJ/cm² to 3,000 mJ/cm² and an irradiation time is preferably in a range from 1 second to 130 seconds.

While examples of the adhesive agent in the adhesive agent layer 30 include a so-called heat-sealing adhesive agent that enables heat-bonding and an adhesive agent that exhibits stickiness when wetted, it is preferable that the adhesive agent layer 30 be a sticky agent layer formed of a sticky agent (a pressure-sensitive adhesive agent) in terms of easiness in application. The sticky agent in the sticky agent layer is not limited. Examples of the sticky agent include an acrylic sticky agent, a urethane sticky agent, a rubber sticky agent, a polyester sticky agent, a silicone sticky agent, and a polyvinyl ether sticky agent. Among the above, the sticky agent is preferably at least one selected from the group consisting of an acrylic sticky agent, a urethane sticky agent, and a rubber sticky agent, more preferably an acrylic sticky agent.

Examples of an acrylic sticky agent include a polymer including a constituent unit derived from alkyl (meth)acrylate having a linear alkyl group or a branched alkyl group (i.e., a polymer where at least alkyl (meth)acrylate is polymerized) and an acrylic polymer including a constituent unit derived from a (meth)acrylate having a ring structure (i.e., a polymer where at least a (meth)acrylate having a ring structure is polymerized). Here, the “(meth)acrylate” is used as a term referring to both “acrylate” and “methacrylate” and the same applies to other similar terms.

In a case where the acrylic polymer is a copolymer, a copolymerization manner is not limited. The acrylic copolymer may be any one of a block copolymer, a random copolymer, and a graft copolymer.

The acrylic copolymer may be cross-linked by a cross-linker. Examples of the cross-linker include a known epoxy cross-linker, isocyanate cross-linker, aziridine cross-linker, and metal chelate cross-linker. In cross-linking the acrylic copolymer, a hydroxyl group, a carboxyl group, or the like, which is reactive with the above cross-linkers, can be introduced into the acrylic copolymer as a functional group derived from a monomer component of the acrylic copolymer.

The adhesive agent layer 30 may further contain an energy-ray-curable component in addition to the above sticky agent.

Examples of the energy-ray-curable component include, in a case where the energy ray is, for instance, an ultraviolet ray, a compound having two or more UV-polymerizable functional groups in one molecule, such as a multifunctional (meth)acrylate compound.

The energy-ray-curable component may be used alone or a mixture of two or more thereof may be used.

In addition, in a case where an acrylic sticky agent is used as the sticky agent, a compound having, in one molecule, both of a functional group reactive with the functional group derived from the monomer component of the acrylic copolymer and an energy-ray-polymerizable functional group may be used as the energy-ray-curable component. Reaction between the functional group of the compound and the functional group derived from the monomer component of the acrylic copolymer enables a side chain of the acrylic copolymer to be polymerizable by energy ray irradiation. Even in a case where the sticky agent is not the acrylic sticky agent, a component likewise having an energy-ray-polymerizable side chain may be used as a copolymer component other than the acrylic polymer.

In a case where the adhesive agent layer 30 is curable with an energy ray, it is favorable that the adhesive agent layer 30 contain a photopolymerization initiator. The photopolymerization initiator enables increasing a speed at which the adhesive agent layer 30 is cured by energy ray irradiation.

The adhesive agent layer 30 may contain a thermosetting component such as an epoxy resin. In a case where the adhesive agent layer 30 is curable with heat, it is preferable that the adhesive agent layer 30 contain a phenol resin, a curing agent such as dicyanamide, a curing catalyst such as an imidazole compound, a heat cationic polymerization initiator, etc. These curing accelerators enable increasing a speed at which the adhesive agent layer 30 is cured by heating.

The adhesive agent layer 30 may contain an inorganic filler. With the inorganic filler contained, a hardness of the cured adhesive agent layer 30 can be further improved. In addition, a heat conductivity of the adhesive agent layer 30 is improved. Further, in a case where an adherend contains glass as a main component, linear expansion coefficients of the sheet-shaped heat generator 10 and the adherend can be closer to each other, thereby improving reliability of a device provided by sticking the sheet-shaped heat generator 10 to the adherend and, if necessary, curing the sheet-shaped heat generator 10.

Examples of the inorganic filler include inorganic powder (e.g., powders of silica, alumina, talc, calcium carbonate, titanium white, colcothar, silicon carbide, and boron nitride), beads of spheroidized inorganic powder, single crystal fiber, and glass fiber. Among the above, a silica filler and an alumina filler are preferable as the inorganic filler. The inorganic fillers may be used alone or two or more thereof may be used in combination.

Other components may be contained in the adhesive agent layer 30. Examples of other components include known additives such as an organic solvent, a flame retardant, a tackifier, an ultraviolet absorber, an antioxidant, a preservative, an antifungal agent, a plasticizer, a defoamer, and a wettability modifier.

A thickness of the adhesive agent layer 30 is determined as desired in accordance with a purpose of use of the sheet-shaped heat generator 10. For instance, the thickness of the adhesive agent layer 30 is preferably in a range from 3 μm to 150 μm in terms of adhesiveness, more preferably in a range from 5 μm to 100 μm.

### Method of Producing Sheet-Shaped Heat Generator

A method of producing the sheet-shaped heat generator 10 according to this exemplary embodiment is not limited. The sheet-shaped heat generator 10 is produced through, for instance, the following process.

First, the core 221 including the first metal is prepared and the metal film 222 including the second metal is formed on the exterior of the core 221. The metal wire 22 is thus obtained. It should be noted that the metal wire 22 may be a commercial product.

The metal film 222 can be formed by subjecting the surface of the core 221 to, for instance, vapor deposition, ion plating, sputtering, or wet plating of a metal itself or a metal alloy. It should be noted that in a case where the intermediate layer is provided in the metal wire 22, the intermediate layer can be formed on the surface of the core 221 by a method similar to the method of forming the metal film 222.

Subsequently, a composition for forming the adhesive agent layer 30 is applied on a release sheet to form a coating film, Subsequently, the coating film is dried to produce the adhesive agent layer 30. Subsequently, the metal wires 22 are placed on the first adhesive surface 30A of the adhesive agent layer 30 while being arranged, whereby the pseudo sheet structure 20 is formed. For instance, while a drum member is turned with the adhesive agent layer 30, on which the release sheet is attached, placed on an outer circumferential surface of the drum member, the metal wires 22 are helically wound on the first adhesive surface 30A of the adhesive agent layer 30. A bundle of the helically wound metal wires 22 is then cut along an axial direction of the drum member. The pseudo sheet structure 20 is thus formed with the plurality of metal wires 22 placed on the first adhesive surface 30A of the adhesive agent layer 30. Then, the adhesive agent layer 30 attached with the release sheet, on which the pseudo sheet structure 20 is formed, is taken off the drum member. After this process, the release sheet is peeled from the adhesive agent layer 30, thus providing the sheet-shaped heat generator 10. Alternatively, the release sheet may be left as a constituent member of the sheet-shaped heat generator 10. According to this method, the interval L between adjacent ones of the metal wires 22 of the pseudo sheet structure 20 is easily adjusted by, for instance, moving a feeder of the metal wires 22 along a direction parallel with an axis of the drum member while turning the drum member.

It should be noted that after the pseudo sheet structure 20 is formed by arranging the metal wires 22, the second surface 20B of the obtained pseudo sheet structure 20 may be stuck onto the first adhesive surface 30A of the adhesive agent layer 30 to produce the sheet-shaped heat generator 10.

### How Sheet-Shaped Heat Generator is Used and Heat Generating Device

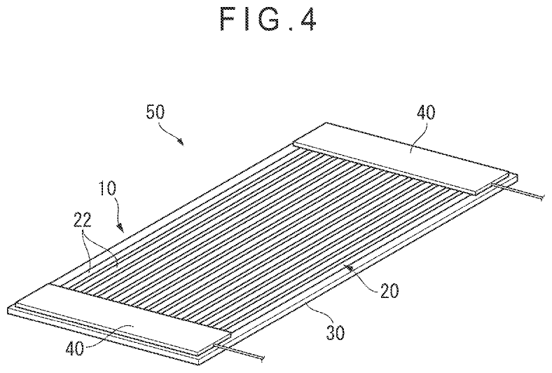

The sheet-shaped heat generator 10 according to this exemplary embodiment, which is a planar heat generator, is suitably usable for planar heat generation. That is to say, it is suitably usable as the sheet-shaped heat generator 10 provided in a heat generating device according to this exemplary embodiment. It should be noted that a heat generating device 50 according to this exemplary embodiment includes the sheet-shaped heat generator 10 and an electrode 40 as illustrated in FIG. 4.

The sheet-shaped heat generator 10 according to the exemplary embodiment is attached to the electrode 40 for supplying power to the metal wires 22 in use. In a heat generating device according to this exemplary embodiment, it is preferable that the single electrode 40 be attached to ends of the plurality of metal wires 22 as illustrated in FIG. 4. In a case where the single electrode 40 is attached to each end of the single metal wire 22, the metal wire 22 between the electrodes 40 may be folded for a plurality of times in a single-stroke arrangement to correspond to a planar form with both ends thereof attached to the respective electrodes 40 (not illustrated). In this case, it is difficult to produce the pseudo sheet structure 20 with narrow intervals between the metal wires 22. Further, a breakage of a part of the metal wire 22 immediately affects the whole thereof. Accordingly, such an implementation is not optimal.

Examples of a technique of electrically connecting the metal wires 22 and the electrode 40 include the following connecting means (1) to (6).

Connecting means (1): The metal wires 22 and the electrode 40 are bonded with a conductive adhesive agent.

Connecting means (2): A composition in which metal particles are dispersed in a resin (e.g., silver paste) or a film formed of a composition in which metal particles are dispersed in a resin is interposed for connection.

Connecting means (3): The metal wires 22 and the electrode 40 are crimped using a metal plate to keep them in contact.

Connecting means (4): A contact portion between the metal wires 22 and the electrode 40 is sandwiched between a male part and a female part of a snap fastener to keep them in contact.

Connecting means (5): A resin film that is meltable by an electromagnetic wave or an ultrasonic wave is provided around the contact portion between the metal wires 22 and the electrode 40 and the resin film is melted by application of an electromagnetic wave or an ultrasonic wave and cured to keep the metal wires 22 and the electrode 40 in contact.

Connecting means (6): The contact portion between the metal wires 22 and the electrode 40 is riveted to keep them in contact.

It is preferable that the metal wires 22 be in contact with the electrode 40 in use for the following reasons.

As the method of reducing the resistance of the connection between the metal wires 22 and the electrode 40 when the sheet-shaped heat generator 10 is attached to the electrode 40 and caused to generate heat, a method where the sheet-shaped heat generator 10 is attached to the electrode 40 with a conductive material such as a silver paste is also applicable.

However, in a case where the sheet-shaped heat generator 10 includes a base material that is relatively weak against heat, the use of a thermosetting conductive material such as a silver paste is usually likely to cause the base material to be damaged by heat. Among base materials, a stretchable base material, which is useful in a case where a conductive sheet is stuck along a curved surface while being stretched or used as a stretchable sheet-shaped heat generator, tends to be weak against heat.

In addition, in a case where the sheet-shaped heat generator 10 includes the adhesive agent layer 30 as illustrated in FIG. 1, it is preferable that the metal wires 22 be fixed to the electrode 40 using the adhesive agent layer 30 in use as illustrated in FIG. 4.

By virtue of bonding using the adhesive agent layer 30, the contact between the metal wires 22 and the electrode 40 can be kept. Also in view of the above, it is preferable that the metal wires 22 and the electrode 40 be in direct contact with each other without additionally forming a silver paste, a conductive adhesive agent, or the like on the electrode 40 also in terms of productivity. As a result of studies by the inventors, it has been found that in a case where the metal wires 22 and the electrode 40 are brought into contact to be electrically connected to each other, a rise in contact resistance due to a failure in contact between the metal wires 22 and the electrode 40 is likely to cause abnormal heat generation. In the sheet-shaped heat generator 10 according to this exemplary embodiment, the second metal of the metal film 222 has the standard electrode potential E_{M2} in the above range, which makes it possible to prevent occurrence of abnormal heat generation even in such a case.

For a heater including typical metal wires, such a method for connecting the metal wires 22 and the electrode 40 is not employed, so that a rise in the resistance between the metal wires 22 and the electrode 40 is not of concern and, accordingly, it is not attempted to apply metal coating such as plating to the wires to reduce the contact resistance between the wires and the electrode 40. For instance, in Example of Patent Literature 2, the electrode 40 and a wire are electrically connected via a silver paste for the purpose of evaluation of heat generation efficiency. Thus, no rise in the contact resistance between the metal wires 22 and the electrode 40 occurs and the wires used in Example of Patent Literature 2 are provided with no metal film.

For instance, known electrode materials such as Al, Ag, Au, Cu, Ni, Pt, and Cr and alloys thereof are usable as a material of the electrode 40 to which the sheet-shaped heat generator 10 is to be attached. A size, number, location, etc. of the electrode 40 may be selected as appropriate in accordance with a purpose of use. It is preferable that the electrode 40 to which the sheet-shaped heat generator 10 is to be attached be in a belt shape so that the plurality of metal wires 22 can be attached thereto.

A distance between the electrodes 40 attached to the sheet-shaped heat generator 10 is determined as appropriate in accordance with a purpose of the use of the sheet-shaped heat generator 10. In a case where the sheet-shaped heat generator 10 is provided in an article with a large area such as a window, a mirror, a signboard, or a sign, the distance between the electrodes 40 is usually in a range from 250 mm to 3000 mm, preferably in a range from 400 mm to 2500 mm, more preferably in a range from 600 mm to 2000 mm.

### Characteristics of Heat Generating Device

A resistance (Q) of the heat generating device 50 according to this exemplary embodiment is preferably 50Ω or more, more preferably in a range from 80Ω to 500Ω, further preferably in a range from 100Ω to 300Ω. In terms of reducing overheating in a case where a voltage to be applied is large, it is preferable that the heat generating device 50 have a high resistance.

The resistance of the heat generating device 50 refers to a resistance between the electrodes 40 measured using an electric tester.

The sheet-shaped heat generator 10 is stuck to, for instance, an adherend that may generate heat in use. Examples of a function of an article obtainable by using the sheet-shaped heat generator 10 in such an adherend include a defogger and a deicer. Incidentally, the sheet-shaped heat generator 10 according to this exemplary embodiment can be prevented from overheating even in a case where used for a purpose requiring a large output. Accordingly, the sheet-shaped heat generator 10 is preferably used for reducing adhesion of snow and ice on a surface, particularly preferably used in a deicer or the like. In this case, examples of the adherend include a window, a mirror, a signboard, a sign, a traffic light, and a display for outdoor use. Examples of the window include windows of devices for transportation (a passenger vehicle, a train, a ship, an airplane, etc.) and a window of a building. Among these adherends, it is preferable that the sheet-shaped heat generator 10 be used in a signboard or a sign with a large area.

In a case where the adhesive agent layer 30 is curable, the adhesive agent layer 30 is cured after the sheet-shaped heat generator 10 is stuck to an adherend.

In sticking the sheet-shaped heat generator 10 to the adherend, a pseudo sheet structure 20 side of the sheet-shaped heat generator 10 may be stuck to the adherend (i.e., stuck to the adherend with the pseudo sheet structure 20 between the first adhesive surface 30A of the adhesive agent layer 30 and the adherend) or the second adhesive surface 30B of the sheet-shaped heat generator 10 may be stuck to the adherend.

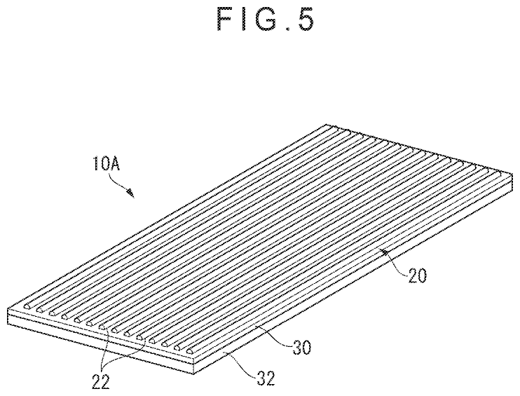

Note that in a case where a base material 32 (see FIG. 5) is not present on a second adhesive surface 30B side of the adhesive agent layer 30, it is preferable that the pseudo sheet structure 20 side of the sheet-shaped heat generator 10 be stuck to the adherend. This is because the pseudo sheet structure 20 is sufficiently protected by both the adherend and the adhesive agent layer 30. The impact resistance of the sheet-shaped heat generator 10 is thus improved, so that the sheet-shaped heat generator 10 is supposed to be suitable for practical use. In addition, the adhesive agent layer 30 contributes to preventing electrical shock when heat is generated (when a current is carried). In this case, as long as the sheet-shaped heat generator 10 includes a later-described release layer 34 on the second adhesive surface 30B of the adhesive agent layer 30, the sheet-shaped heat generator 10 exhibits improved shape retainability until the sheet-shaped heat generator 10 is stuck to the adherend. The release layer 34 is peeled and removed after the sheet-shaped heat generator 10 is stuck to an adherend. In a case where the adhesive agent layer 30 is to be cured, the release layer 34 may be removed either before or after the curing.

### Second Exemplary Embodiment

Next, description will be made on a second exemplary embodiment of the invention on the basis of the drawing.

It should be noted that this exemplary embodiment is similar in configuration to the first exemplary embodiment except that a sheet-shaped heat generator 10A is used in place of the sheet-shaped heat generator 10. Accordingly, the sheet-shaped heat generator 10A will be described and description of the other components will be omitted.

The sheet-shaped heat generator 10A according to this exemplary embodiment includes the base material 32 stacked on the second adhesive surface 30B of the adhesive agent layer 30 as illustrated in FIG. 5.

Examples of the base material 32 include paper, non-woven fabric, woven fabric, a thermoplastic resin film, a cured film of a curable resin, metallic foil, and glass film. Examples of the thermoplastic resin film include polyester, polycarbonate, polyimide, polyolefin, polyurethane, and acrylic resin films. In addition, it is preferable that the base material 32 exhibit stretchability in terms of facilitation of sticking onto a curved surface of an adherend.

It should be noted that a surface of the base material 32 not facing the adhesive agent layer 30 (a surface exposed through the sheet-shaped heat generator 10A) may be subjected to, for instance, a hard coating treatment with an ultraviolet curable resin or the like to enhance protectiveness for the sheet-shaped heat generator 10A (the pseudo sheet structure 20).

### Third Exemplary Embodiment

Next, description will be made on a third exemplary embodiment of the invention on the basis of the drawing.

It should be noted that this exemplary embodiment is different in that the sheet-shaped heat generator 10 according to the first exemplary embodiment further includes at least one release layer 34. Since this exemplary embodiment is similar in configuration to the first exemplary embodiment except the above, the release layer 34 will be described and description of the other components will be omitted.

A sheet-shaped heat generator 10B according to this exemplary embodiment includes, for instance, the release layer 34 stacked on at least one of the first surface 20A of the pseudo sheet structure 20 or the second adhesive surface 30B of the adhesive agent layer 30.

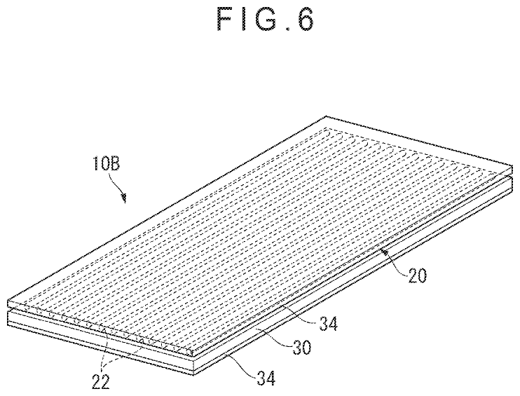

It should be noted that FIG. 6 illustrates the sheet-shaped heat generator 10B including the release layer 34 stacked on both the first surface 20A of the pseudo sheet structure 20 and the second adhesive surface 30B of the adhesive agent layer 30.

The release layer 34 is not limited. For instance, it is preferable that the release layer 34 include a release base material and a release agent layer formed by applying a release agent onto the release base material in terms of handleability. In addition, the release layer 34 may include the release agent layer only on one surface of the release base material or include the release agent layers on both surfaces of the release base material.

Examples of the release base material include a paper base material, a laminated paper including a paper base material or the like with a thermoplastic resin (e.g., polyethylene) laminated thereon, and a plastic film. Examples of the paper base material include glassine paper, coated paper, and cast-coated paper. Examples of the plastic film include a polyester film (e.g., polyethylene terephthalate, polybutylene terephthalate, and polyethylene naphthalate) and a polyolefin film (e.g., polypropylene and polyethylene). Examples of the release agent include an olefin resin, a rubber elastomer (e.g., a butadiene resin and an isoprene resin), a long-chain alkyl resin, an alkyd resin, a fluorine resin, and a silicone resin.

A thickness of the release layer 34 is not limited. The thickness of the release layer 34 is preferably in a range from 20 μm to 200 μm, more preferably in a range from 25 μm to 150 μm.

A thickness of the release agent layer of the release layer 34 is not limited. In a case where the release agent layer is formed by application of a solution containing the release agent, the thickness of the release agent layer is preferably in a range from 0.01 μm to 2.0 μm, more preferably in a range from 0.03 μm to 1.0 μm.

In a case where a plastic film is used as the release base material, a thickness of the plastic film is preferably in a range from 3 μm to 150 μm, more preferably in a range from 5 μm to 100 μm.

### Fourth Exemplary Embodiment

Next, description will be made on a fourth exemplary embodiment of the invention on the basis of the drawing.

It should be noted that this exemplary embodiment is different in that the pseudo sheet structure 20 of the sheet-shaped heat generator 10 according to the first exemplary embodiment is replaced with a pseudo sheet structure 20C. Since this exemplary embodiment is similar in configuration to the first exemplary embodiment except the above, the pseudo sheet structure 20C will be described and description of the other components will be omitted.

A sheet-shaped heat generator 10C according to this exemplary embodiment includes the pseudo sheet structure 20C, a metal wire 22C of which may be periodically curved or bent. Specifically, the metal wire 22C may be in a wavy shape such as a sinusoidal wave, a rectangular wave, a triangular wave, and a sawtooth wave. In other words, the pseudo sheet structure 20C may have a structure in which, for instance, a plurality of unidirectionally extending metal wires 22C in a wavy shape are arranged in a direction perpendicular to a direction of the extension of the metal wires 22C at regular intervals. By virtue of the pseudo sheet structure 20C including the periodically curved or bent metal wires 22C, in a case where the sheet-shaped heat generator 10C is stretchable, the metal wires 22C are likely to follow the stretching. In this case, the sheet-shaped heat generator IC may be irreversibly stretchable and stretched to be placed on an object in a shape having a curved surface in use or may be reversibly stretchable.

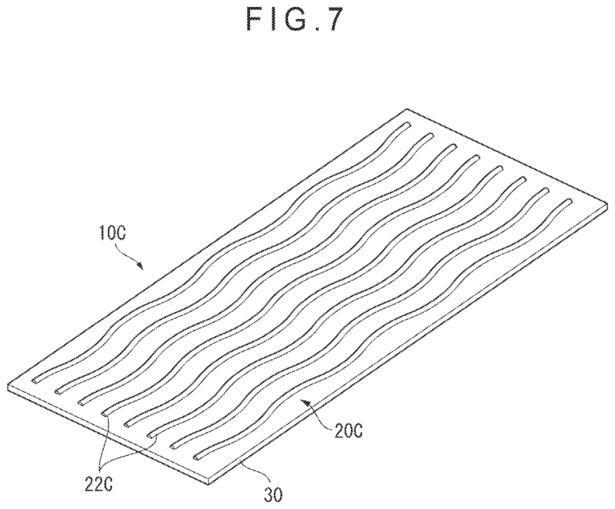

It should be noted that FIG. 7 illustrates the sheet-shaped heat generator 10C including the pseudo sheet structure 20C in which the plurality of unidirectionally extending metal wires 22C in a wavy shape are arranged in the direction perpendicular to the direction of the extension of the metal wires 22C at regular intervals.

### Fifth Exemplary Embodiment

Next, description will be made on a fifth exemplary embodiment of the invention on the basis of the drawings.

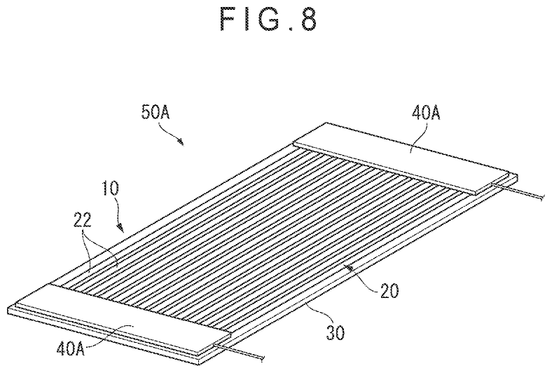

It should be noted that description will be made on an implementation where a sheet-shaped heat generator is used as a heat generator in a heat generating device in this exemplary embodiment. A heat generating device 50A according to this exemplary embodiment includes the sheet-shaped heat generator 10 according to the first exemplary embodiment and an electrode 40A that supplies power to the sheet-shaped heat generator 10 as illustrated in FIG. 8. That is to say, the heat generating device 50A according to this exemplary embodiment includes the electrode 40A in place of the electrode 40 in the heat generating device of the first exemplary embodiment.

Specifically, in the heat generating device 50A including the electrode 40A, at least a part of the plurality of metal wires 22 of the sheet-shaped heat generator 10 are arranged to be connected to the electrode 40A, a surface of the electrode 40A connected to the metal wires 22 is formed of a third metal, and a standard electrode potential (hereinafter, also referred to as “standard electrode potential E_{M3}”) of the third metal is +0.5 V or more.

At the standard electrode potential E_{M3} of the third metal of ±0.5 V or more, corrosion resistance of the electrode is improved. Consequently, it is possible to prevent a rise in contact resistance between the electrode and the metal wires resulting from corrosion of the electrode due to an influence of temperature and humidity in storage and in use. This enables reducing an increase in heat generation of the electrode part during the use of the heat generating device 50A due to the influence of the temperature and the humidity.

Therefore, regarding the heat generating device 50A including the electrode 40A, the standard electrode potential E_{M2} of the second metal forming the metal film of the metal wires 22 is +0.34 V or more and the standard electrode potential of the surface of the electrode 40A connected to the metal wires 22 is +0.5 V or more, which enables the resistance of the connection between the metal wires 22 and the electrode 40A to be further reduced to further prevent abnormal heat generation of the electrode part.

The electrode 40A is not limited at least as long as the surface of the electrode 40A connected to the metal wires 22 is formed of the third metal.

### Third Metal

The standard electrode potential E_{M3} of the third metal is +0.5 V or more, preferably +0.7 V or more, more preferably ±0.9 V or more. An upper limit of the standard electrode potential E_{M3} of the third metal is preferably +2.0 V or less, more preferably +1.6 V or less.

The standard electrode potential E_{M3} of the third metal is a material-inherent value and a known value. It should be noted that the third metal is a concept including alloy.

Examples of the third metal include metals containing, as main components, gold, platinum, palladium, silver, copper, and an alloy. Examples of the alloy include an alloy containing, as a main component, an alloy containing at least one metal selected from the group consisting of gold, platinum, palladium, silver, and copper. It should be noted that the alloy is preferably an alloy of metals selected from the group consisting of gold, platinum, palladium, silver, and copper, however, an alloy containing a metal other than the above, such as nickel, iron, or cobalt, is also acceptable as long as the content thereof is small enough to provide only a small influence on the standard electrode potential of the second metal. Examples of such an alloy include a gold-nickel alloy, a gold-iron alloy, and a gold-cobalt alloy.

The third metal preferably contains, as a main component, at least one selected from the group consisting of gold, platinum, palladium, silver, copper, and the alloy (an alloy containing at least one metal selected from the group consisting of gold, platinum, palladium, silver, and copper), more preferably contains, as a main component, at least one selected from the group consisting of gold, platinum, palladium, silver, and the alloy.

Here, the wording “contain . . . as a main component” means that the above metal accounts for 50 mass % or more of the entirety of the third metal. A ratio of the above metal to the entirety of the third metal is preferably 80 mass % or more, more preferably 90 mass % or more, further preferably 100 mass %. In addition, in a case where the metal contained as a main component is an alloy, which may be a gold-nickel alloy, the above mass ratio refers to a mass ratio of the total amount of gold and nickel.

Examples of an implementation of the electrode 40A include 1) an implementation in which the electrode is entirely formed of the third metal, 2) an implementation in which the electrode includes an electrode base and a coating layer, the coating layer being provided at least on a surface of the electrode base connected to the metal wires 22, the coating layer being formed of the third metal, and 3) an implementation in which a buffer layer is further provided between the electrode base and the coating layer in the implementation of 2).

The electrode base is not limited as long as a material thereof allows for forming the coating layer formed of the third metal on the surface. A known electrode is usable as the electrode base. Examples of the coating layer include a coating layer formed by a known method such as electroplating, electroless plating, sputtering, vapor deposition, or spin coating. A thickness of the coating layer is preferably in a range from 0.01 μm to 3 μm, more preferably in a range from 0.02 μm to 1 μm, further preferably in a range from 0.03 μm to 0.7 μm.

Examples of the buffer layer include layers of metals different from the third metal, such as a nickel layer, a nickel alloy layer, a tin layer, a tin alloy layer, a copper alloy layer, a niobium layer, a niobium alloy layer, a titanium layer, a titanium alloy layer, a molybdenum layer, a molybdenum alloy layer, a tungsten layer, a tungsten alloy layer, a palladium alloy layer, and a platinum alloy layer. A thickness of the buffer layer is preferably in a range from 0.01 μm to 1 μm, more preferably in a range from 0.02 μm to 1 μm, further preferably in a range from 0.03 μm to 0.7 μm.

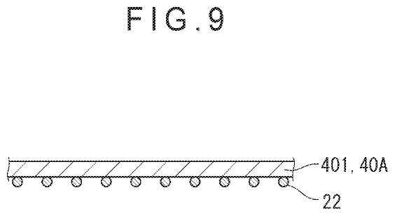

Examples of a preferable implementation of the electrode 40A include electrodes illustrated in FIG. 9 to FIG. 11.

FIGS. 9 to 11 are each a cross-sectional view illustrating an implementation of contact between the electrode and the metal wires. It should be noted that the electrodes illustrated in FIG. 9 to FIG. 11 correspond to the implementations of the electrode of 1) to 3), respectively.

An electrode 401 illustrated in FIG. 9, which is entirely formed of the third metal, corresponds to the implementation of the electrode of 1). FIG. 9 illustrates that the electrode 401 formed of the third metal and the metal film of each of the metal wires 22 are in contact with each other.

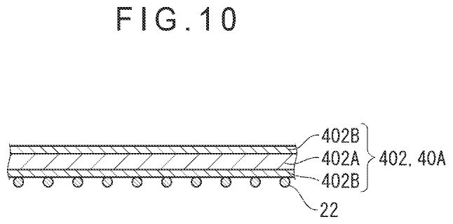

An electrode 402 illustrated in FIG. 10, which includes an electrode base 402A and a coating layer 402B formed on a surface of the electrode base 402A, corresponds to the implementation of the electrode of 2). FIG. 10 illustrates that the coating layer 402B formed of the third metal and the metal film of each of the metal wires 22 are in contact with each other.

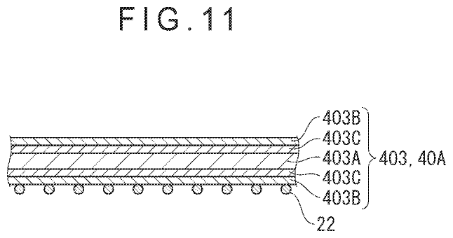

An electrode 403 illustrated in FIG. 11, which includes an electrode base 403A, a buffer layer 403C formed on a surface of the electrode base 403A, and a coating layer 403B formed on a surface of the buffer layer 403C, corresponds to the implementation of the electrode of 3). FIG. 11 illustrates that the coating layer 4038 formed of the third metal and the metal film of each of the metal wires 22 are in contact with each other.

### Other Exemplary Embodiments

The scope of the invention is not limited to the above exemplary embodiments and modifications, improvements, etc. are included within the scope of the invention as long as they are compatible with an object of the invention.

For instance, although the pseudo sheet structure is in the form of a single layer in the above exemplary embodiments, the scope of the invention is not limited thereto. For instance, the sheet-shaped heat generator may be in the form of a sheet including a plurality of pseudo sheet structures arranged in a sheet-plane direction (a direction along a sheet surface). The plurality of pseudo sheet structures may be arranged with the respective metal wires thereof being in parallel with each other or intersecting each other in a plan view of the sheet-shaped heat generator.

The sheet-shaped heat generators according to the first exemplary embodiment to the fourth exemplary embodiment may each include another adhesive agent layer on the first surface 20A (see FIG. 2) of the pseudo sheet structure. In this case, it is preferable that a pressure be applied to the sheet-shaped heat generator at the same time when or after the sheet-shaped heat generator is stuck to an adherend to cause the metal wires to sink into the other adhesive agent layer such that the metal wires come into contact with the electrode or the conductive adhesive agent or the like present between the metal wires and the electrode.

The adhesive agent layer 30 and the other adhesive agent layer may have the same composition or different compositions.

A thickness of the other adhesive agent layer is preferably in a range from 3 μm to 150 μm, more preferably in a range from 5 μm to 100 μm as the thickness of the adhesive agent layer 30.

The sheet-shaped heat generator may include an electrode sandwiched between layers of the pseudo sheet structure and the other adhesive agent layer and may include another base material on a surface of the other adhesive agent layer opposite a surface facing the pseudo sheet structure. For instance, in a case of the second exemplary embodiment, the sheet-shaped heat generator 10A may have, in a region where the electrode is formed in a plan view, a stacking structure of the base material 32/the adhesive agent layer 30/the pseudo sheet structure 20/the electrode/the other adhesive agent layer/the other base material. In such an exemplary embodiment, the respective base materials are present on outermost surfaces of the sheet-shaped heat generator 10A on both sides with the contact between the electrode and the pseudo sheet structure 20 kept, which allows a user to place the sheet-shaped heat generator 10A as a single independent sheet at a desired target portion at his/her discretion. In addition, the sheet-shaped heat generator 10A has, in a region where no electrode is formed in a plan view, a stacking structure of the base material 32/the adhesive agent layer 30/the pseudo sheet structure 20/the other adhesive agent layer/the other base material, which enhances an effect in preventing position deviation of the metal wires 22 or the like by virtue of the presence of the other adhesive agent layer between the metal wires 22 in the pseudo sheet structure and the other base material. It should be noted that the metal wires 22 may be the metal wires 22C in a wavy shape (see FIG. 7).

The sheet-shaped heat generators according to the first exemplary embodiment to the fourth exemplary embodiment may each include another adhesive agent layer on the second adhesive surface 30B (see FIG. 2) of the adhesive agent layer 30 with a support layer in between.

Examples of the support layer include paper, a thermoplastic resin film, a cured film of a curable resin, metallic foil, and glass film. Examples of the thermoplastic resin film include polyester, polycarbonate, polyimide, polyolefin, polyurethane, and acrylic resin films.

The heat generating device 50A according to the fifth exemplary embodiment may include the sheet-shaped heat generator 10 that is different from the sheet-shaped heat generator of the first exemplary embodiment. For instance, the sheet-shaped heat generator 10 may include no adhesive agent layer 30. In this implementation, it is preferable that at least a part of the pseudo sheet structure 20 be fixed to an adherend by fixing means. For instance, an edge portion of the pseudo sheet structure 20 may be fixed to the adherend using a fixing member, only a pair of opposite edge portions of the pseudo sheet structure 20 (only pairs of opposite ends of the plurality of metal wires 22) may be fixed to the adherend using the fixing member, or the entirety of the pseudo sheet structure 20 may be fixed to the adherend using the fixing member.

The fixing means is not limited but examples thereof include a double-sided tape, a heat-sealing film, solder, and a holding tool (e.g., a clip and a vise). It is preferable that the fixing means be selected as appropriate for a material of the adherend. A location of the fixing means is not limited.

### EXAMPLES

The invention will be more specifically described with reference to Examples. It should be noted that these Examples are not intended to limit the scope of the invention.

### Example 1

A base material with a sticky agent, which included a 0.5-mm-thick polycarbonate plate and a sticky agent layer (a pressure-sensitive adhesive agent layer) provided thereon, was prepared as the base material.

In addition, a sticky sheet (“Lumicool 1321PS” manufactured by LINTEC Corporation) was prepared.

Further, a gold-plated stainless steel wire (manufactured by TOKUSAI TungMoly Co., LTD.) was prepared as the metal wire. Regarding this metal wire, a thickness of a metal film of gold plating is 0.1 μm and a diameter including the plating layer is 25 μm. The first metal is stainless steel and the second metal is gold.

Next, the sticky sheet was creaselessly wound on a drum member having a rubber outer circumferential surface with a surface of the pressure-sensitive adhesive agent layer facing outward and both circumferential ends of the sticky sheet were fixed with a double-sided tape. After the metal wire wound on a bobbin was attached to the surface of the pressure-sensitive adhesive agent layer of the sticky sheet placed near an end of the drum member, the metal wire was reeled on the drum member while being unwound and the drum member was moved little by little in directions parallel with a drum shaft alternately at regular intervals, causing the metal wire to be helically wound on the drum member such that the metal wire had periodic bends (a wavy shape) with a total amplitude of 6.5 mm and a wavelength of 5 mm. The interval between the metal wires was 10 mm. A pseudo sheet structure of the metal wires was thus formed by arranging the plurality of metal wires on the surface of the pressure-sensitive adhesive agent layer of the sticky sheet with a constant distance between adjacent ones of the metal wires maintained. The sticky sheet was cut in parallel with the drum shaft along with the metal wires, whereby a sheet-shaped heat generator with the pseudo sheet structure stacked on the adhesive agent layer was obtained.

In addition, a pair of strip-shaped copper plate electrodes (manufactured by TERAOKA SEISAKUSHO CO., LTD., width: 10 mm, length: 210 mm, thickness: 70 μm) were placed on the above base material with a sticky agent in parallel with each other at a space of 750 mm therebetween and in alignment with both ends. The produced sheet-shaped heat generator was then stuck to an electrode installation position with a longitudinal direction of the metal wires being perpendicular to a longitudinal direction of the electrodes. The sheet-shaped heat generator and the electrodes were bonded to each other with the sticky agent layer exposed between the metal wires. At this time, adjustment was made to cause the number of the metal wires connected between both electrodes to be 10. The metal wires were thus brought into contact with both electrodes, whereby a sheet-shaped heat generating device was obtained.

### Comparative Example 1

A sheet-shaped heat generator and a heat generating device were obtained in a similar manner to those of Example 1 except that a stainless steel wire with no metal film formed therearound (manufactured by TOKUSAI TungMoly Co., LTD.) was used as the metal wire. It should be noted that a diameter of this metal wire is 25 μm.

### Comparative Example 2

A sheet-shaped heat generator and a heat generating device were obtained in a similar manner to those of Example 1 except that a gold-plated tungsten wire (manufactured by TOKUSAI TungMoly Co., LTD.) was used as the metal wire. Regarding this metal wire, a thickness of a metal film of gold plating is 01 μm and a diameter including the plating layer is 25 μm. The first metal is tungsten and the second metal is gold.

### Various Characteristic Values and Measurement

### Volume Resistivity and Standard Electrode Potential

Table 1 shows volume resistivities and standard electrode potentials of the metals used in the examples.

### Diameter D of Metal Wires, Thickness of Metal Film, Etc.

The diameter D of the metal wires of the sheet-shaped heat generator obtained in each example was measured in accordance with the described method. Table 1 shows measurement results of the diameter D of the metal wires, the thickness of the metal film, etc.

TABLE 1

| | Core | | | Metal Film | | | | |
|---|---|---|---|---|---|---|---|---|
| | | Volume | Standard | | Volume | Standard | | |
| | Metal | Resistivity | Electrode | Metal | Resistivity | Electrode | | Diameter D |
| | Species | R_{M1} | Potential | Species | R_{M1} | Potential | Thickness | of Metal |
| | (1st Metal) | (Ω · cm) | E_{M1} (V) | (2nd Metal) | (Ω · cm) | E_{M1} (V) | (μm) | Wires (μm) |
| Ex. 1 | Stainless Steel | 7.3 × 10⁻⁵ | <+0.34 | Gold | 2.4 × 10⁻⁶ | +1.52 | 0.1 | 25 |
| Comp. 1 | Stainless Steel | 7.3 × 10⁻⁵ | <+0.34 | — | — | — | — | 25 |
| Comp. 2 | Tungsten | 5.7 × 10⁻⁶ | <+0.34 | Gold | 2.4 × 10⁻⁶ | +1.52 | 0.1 | 25 |

### Evaluation of Heat Generating Device

Rise Rate of Resistance Between Electrodes (Resistance of Heat Generating Device) after Storage Under Hygrothermal Environment

A resistance R₁ [Ω] between both electrodes of the heat generating device produced in each example was measured using an electric tester.

Next, the heat generating device produced in each example was stored under hygrothermal environment where an 85-degrees-C relative humidity was 85% for 20 hours and a resistance R₂ (a resistance R₂ between the electrodes after the storage under the hygrothermal environment) [Ω] was measured by the same method as the resistance R₁. A rise rate (a value given by multiplying (R₂−R₁)/R₁ by 100) [%] of the resistance between the electrodes after the storage under the hygrothermal environment was calculated from values of R₁ and R₂. Table 2 shows results.

### Heat Generation of Parts

A voltage of 200 V was applied between both electrodes of the heat generating device having been stored under the hygrothermal environment described above and, after the elapse of 30 seconds, a temperature of the electrode part in contact with the metal wires was measured using a radiation thermometer (manufactured by FIR Systems, Inc., Product No. C2). In a case where the temperature of the electrode part was higher than that of a heat generation portion other than the electrode part, abnormal heat generation was determined to be “Yes”. In a case where the temperature of the electrode part was equal to or lower than the temperature of the heat generation portion other than the electrode part, abnormal heat generation was determined to be “No” Table 2 shows results. It should be noted that regarding Comparative Example 2, measurement was not possible due to occurrence of overheating.

In addition, a power density [W/cm²] was calculated from values of an applied voltage [V], a resistance value [R], and a heating area [cm²] on the basis of an expression below. Table 2 shows results.

(power density)=(applied voltage)²/{(resistance value)×(heating area)}

TABLE 2

| | | | | Heat Generation of Each Part | | | |
|---|---|---|---|---|---|---|---|
| | Resistance Between Electrodes | | | Power | Other than | Electrode | Abnormal Heat |
| | Resistance | Resistance | Rise Rate | Density | Electrode | Portion | Generation of |
| | R₁ (Ω) | R₂ (Ω) | (%) | (W/cm²) | Portion (° C.) | (° C.) | Electrode Part |
| Ex. 1 | 165 | 164 | −0.6 | 0.16 | 95 | 40 | No |
| Comp. 1 | 180 | 205 | 13.9 | 0.14 | 90 | 110 | Yes |
| Comp. 2 | 13 | 13 | 0.0 | 2.11 | — | — | — |

As shown in Table 2, in Example 1, in which the metal wire including the core including the first metal as a main component and the metal film including the second metal as a main component on the exterior of the core was used, the rise rate of the resistance between the electrodes was small as compared with in Comparative Example 1, in which the stainless steel wire with no metal film was used, and no abnormal heat generation of the electrode part occurred.

In addition, regarding Comparative Example 2, in which the gold-plated tungsten wire was used, it has been found that overheating occurs as a result of a voltage as high as 200 V being applied between both electrodes.

Therefore, the sheet-shaped heat generator according to Example can be prevented from overheating even in a case where the sheet-shaped heat generator is used for a purpose requiring a large output. Further, when attached to an electrode and caused to generate heat, a resistance of a connection between a metal wire and the electrode can be reduced. In addition, abnormal heat generation of the electrode part can be reduced.

### EXPLANATION OF CODE(S)

10, 10A, 10B, 10C . . . sheet-shaped heat generator, 20, 20C . . . pseudo sheet structure, 20A . . . first surface, 20B . . . second surface, 22, 22C . . . metal wire, 30 . . . adhesive agent layer, 30A . . . first adhesive surface, 30B . . . second adhesive surface, 32 . . . base material, 34 . . . release layer, 40 . . . electrode, 50, 50A . . . heat generating device, 221 . . . core, 222 . . . metal film, 40A, 401, 402, 403 . . . electrode, 402A, 403A . . . electrode base, 4028, 403B . . . coating layer, 403C . . . buffer layer

1. A sheet-shaped heat generator comprising a pseudo sheet structure comprising a plurality of metal wires arranged at an interval, the metal wires each comprising a core comprising a first metal and a metal film provided on an exterior of the core, the metal film comprising a second metal different from the first metal, wherein
a volume resistivity of the first metal is in a range from 1.0×10⁻⁵ [Ω·cm] to 5.0×10⁻⁴ [Ω·cm], and
a standard electrode potential of the second metal is +0.34 V or more.

2. The sheet-shaped heat generator according to claim 1, wherein the interval between the metal wires is in a range from 0.3 mm to 30 mm.

3. The sheet-shaped heat generator according to claim 1, wherein a diameter of each of the metal wires is in a range from 5 μm to 150 μm.

4. The sheet-shaped heat generator according to claim 1, wherein the first metal comprises, as a main component, at least one metal selected from the group consisting of titanium, stainless steel, and iron-nickel.

5. The sheet-shaped heat generator according to claim 1, wherein the second metal comprises, as a main component, at least one metal selected from the group consisting of silver and gold.

6. The sheet-shaped heat generator according to claim 1, wherein the sheet-shaped heat generator comprises an adhesive agent layer and the pseudo sheet structure is in contact with the adhesive agent layer.

7. The sheet-shaped heat generator according to claim 1, wherein the sheet-shaped heat generator is usable for reducing adhesion of snow and ice on a surface.

8. A heat generating device comprising:
the sheet-shaped heat generator according to claim 1; and
electrodes.

9. The heat generating device according to claim 8, wherein the second metal of the metal wires is brought into contact with the electrodes in use.

10. The heat generating device according to claim 8, wherein the metal wires are fixed to the electrodes using the adhesive agent layer in use.
